(19) United States
(12) Patent Application Publication
(10) Pub. No.: US 2021/0025520 A1
(43) Pub. Date: Jan. 28, 2021

(54) ASSEMBLY COMPRISING A DOUBLE WALL PE SUMP AND AN ELECTRO-WELDABLE PENETRATION FITTING AND RELATIVE INSTALLATION METHOD

(71) Applicant: NUPI INDUSTRIE ITALIANE S.p.A., Busto Arsizio, VA (US)

(72) Inventor: Marco GENONI, ARESE (IT)

(21) Appl. No.: 16/933,394

(22) Filed: Jul. 20, 2020

(30) Foreign Application Priority Data
Jul. 26, 2019 (IT) 102019000013008

(51) Int. Cl. F16L 13/02; F16L 5/00

(52) U.S. Cl. CPC F16L 13/0209; F16L 5/00

(57) ABSTRACT

An assembly including a double wall PE sump and an electro-weldable penetration fitting, wherein the sump is provided with two walls identifying an interspace therebetween and wherein at least an electro-weldable penetration fitting is applied to the sump at at least a circular opening prepared for the passage through the two walls by a conduit. The penetration fitting includes a cylindrical sleeve internally defining a tubular passage and provided with a threaded portion on the outer surface of a first end, with a cylindrical portion on the opposite end, and centrally with a stop shoulder, as well as with a welding zone, having a heat transfer component, provided between the threaded portion and the stop shoulder. The penetration fitting also includes a locking ring at least provided with a smooth cylindrical portion that can be coupled with the welding zone of the cylindrical sleeve provided with the heat transfer component.

### CROSS-REFERENCE TO RELATED APPLICATIONS

This application is related to, and claims the benefit of Italian Patent Application No. 102019000013008, filed on Jul. 26, 2019, the contents of which are herein incorporated by reference in their entirety.

### TECHNICAL FIELD

The present disclosure relates to an assembly comprising a double wall PE sump and an electro-weldable penetration fitting and a relative installation method.

### BACKGROUND

At present, the problem of the sealed connection of a through pipe for double wall PE sumps which is able to adequately isolate the opening of the double wall passed by the through pipe has not been resolved, but above all that is able to isolate the interspace between the two walls of the sump.

Only in the case of fibreglass sumps is a penetration fitting actually used, fixed by adhesive on the external front of both walls of the sump to make the opening passed by the through pipe watertight and to isolate the interspace between the walls.

Only by maintaining the integrity of the interspace between the sump walls is it possible to check for leaks by monitoring the same, which for example involves pressurizing the interspace.

Furthermore, in the use of double wall pipes passing through the double wall of the sump, it is also crucial to ensure the mutual isolation between the interspaces respectively between the two walls of the sump and between the walls of the internal and external coaxial pipes, since the two interspaces are monitored through pressurization with maximum pressures that can be different from each other.

### SUMMARY

The present disclosure provides an assembly comprising a double wall PE sump and an electro-weldable penetration fitting and a relative installation method, which allow to maintain the integrity of the interspace between the two walls of the sump.

The present disclosure provides an assembly comprising a double wall PE sump and an electro-weldable penetration fitting and a relative installation method that keep the interspaces isolated between the double wall of the sump and between the internal and external pipes respectively in the case of double wall pipes.

The present disclosure provides an assembly comprising a double wall PE sump and an electro-weldable penetration fitting and a relative particularly simple and functional installation method, with low costs.

These advantages according to the present disclosure are achieved by providing an assembly comprising a double wall PE sump and an electro-weldable penetration fitting and a relative installation method as shown in the independent claims.

Further features are comprised in the dependent claims.

### BRIEF DESCRIPTION OF THE DRAWINGS

The characteristics and advantages of an assembly comprising a double wall PE sump and an electro-weldable penetration fitting and of a relative installation method according to the present disclosure will be more evident from the following description, provided as a non-limiting example, referring to the enclosed schematic drawings in which:

FIGS. 1 and 2 show an enlarged detail of an assembly comprising a double wall PE sump and an electro-weldable penetration fitting, according to the disclosure, respectively put into operation in association with different types of conduits;

FIG. 3 is a perspective view of FIG. 1; and

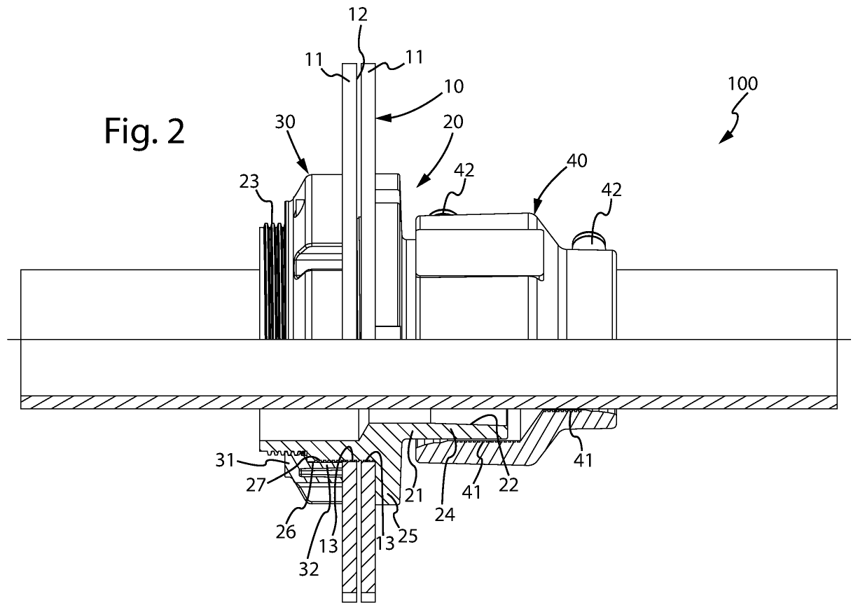

FIG. 4 is an enlarged sectional detail of the assembly according to the disclosure showing the welding zone between the double wall of the sump and the penetration fitting.

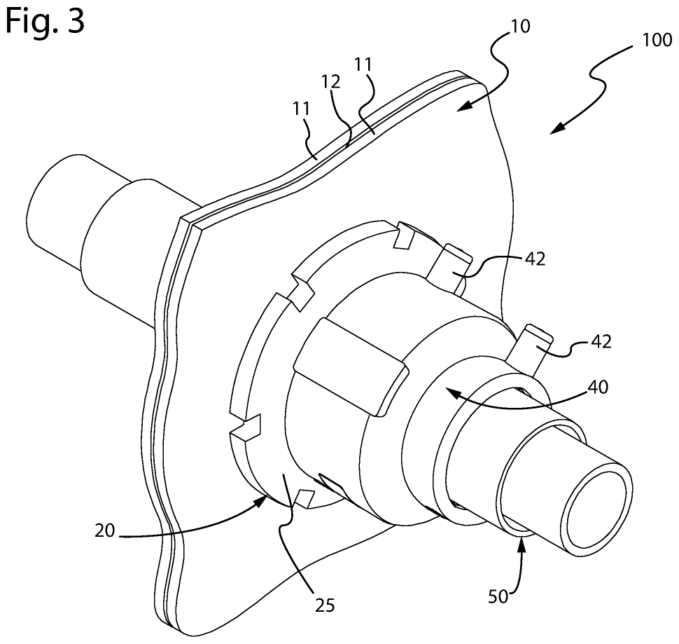

### DETAILED DESCRIPTION OF THE DRAWINGS

With reference to the figures, an assembly indicated as a whole with 100 comprising a double wall PE sump 10 and an electro-weldable penetration fitting 20 is shown.

The sump 10 is provided with two walls 11 which are coupled and identify an interspace 12 therebetween.

The sump 10 is provided with one or more circular openings 13 arranged for the passage of as many conduits 50, at each of which the sump 10 has the electro-weldable penetration fitting 20.

The penetration fitting 20 comprises a cylindrical sleeve 21, internally defining a tubular passage 22 and provided with a threaded portion 23 on the outer surface of a first end, with a smooth cylindrical portion 24 at an opposite end. Centrally, the cylindrical sleeve 21 is provided with a stop shoulder 25, as well as a welding zone 26, having heat transfer means 27, provided between the threaded portion 23 and the stop shoulder 25.

The penetration fitting 20 also comprises a locking ring 30 which is preferably provided with a threaded portion 31, which can be coupled to the threaded portion 23 of the first end of the cylindrical sleeve 21, and a smooth cylindrical portion 32, which can be coupled to the welding zone 26 which has the heat transfer means 27 of the cylindrical sleeve 21.

The heat transfer means 27 of the cylindrical sleeve 21 are preferably realized through a metal wire wound in a spiral on the surface of the cylindrical sleeve 21, in particular wound in a spiral about the cylindrical sleeve 21 and housed in special seats realized at the outer surface of the sleeve 21, or embedded near the same.

The electric wire ends in two electric contacts accessible from the outside, not shown, for the purpose of applying electricity.

At least the surface portion of the sleeve 21 at the welding zone 26, along which the heat transfer means 27 are arranged, is made of heat-sealable material, such as plastic material, for example polyethylene. Correspondingly, at least the smooth cylindrical portion 32 of the locking ring 30 is also made of heat-sealable material, such as plastic material, for example polyethylene.

The installation of the assembly 100 comprising a double wall PE sump 10 and an electro-weldable penetration fitting 20 according to the disclosure provides for positioning the sleeve 21 within the opening 13 realized in the two walls 11 of the sump 10 with the stop shoulder 25 abutting against a side of the double wall 11.

The locking ring 30 is axially coupled to the sleeve 21 on the opposite side of the double wall 11 with respect to the stop shoulder 25, until it tightens the two walls 11 of the sump, preferably by screwing.

The electrical contacts are connected to a source of electricity which requires the passage of electric current through the heat transfer means 27. This passage of electric current leads to the generation of heat which is transferred to the zones adjacent to the heat transfer means 27, i.e. the welding zone 26 of the cylindrical sleeve 21, the walls 11 of the sump 10 and the smooth portion 32 of the locking ring 30.

The fusion welding of the heated materials in contact with each other therefore takes place, i.e. a fixed and sealed coupling respectively between the welding zone 26 of the cylindrical sleeve 21 and the cylindrical surfaces facing it, i.e. the cylindrical surfaces of the openings 13 of the walls 11 of the sump 10 and, if present, the smooth portion 32 of the locking ring 30.

In particular, the thickness of the two walls 11 is welded along the circular surface which identifies the opening 13 and the cylindrical sleeve 21.

This advantageously leads to the creation of a seal between the sleeve 21 and each of the walls 11, which extends for the entire perimeter of the opening 13 realized in the walls 11. The perfect isolation of the interspace 12 between the two walls 11 is thus guaranteed.

At the same time, the welding of the locking ring 30 to the sleeve 21 creates a non-releasable constraint therebetween which guarantees the seal over time of the connection of the penetration fitting 20 to the sump 10.

Furthermore, according to the disclosure, the fitting 20 can be applied both from the inside and from the outside of the sump 10.

In the assembly 100 according to the disclosure, the length of the welding zone z, shown in the enlarged detail of FIG. 5, is equal to or less than the sum of the overall thickness p of the sump 10 and of the length 1 of the smooth surface 32 of the locking ring 30.

The overall thickness p of the sump 10 is intended as the sum of the thickness of the two walls 11 and the interspace 12.

In any case, the length of the welding zone z must regardless be greater than the overall thickness p of the sump 10.

Generally, the sump has an overall thickness p of between 10 and 40 mm, more frequently between 12 and 28 mm. In this case, the welding zone z is generally respectively between 11 and 45 mm, and between 13 and 30 mm.

In particular, preferably, the length of the welding zone z must be at least 5 mm greater than the overall thickness p of the sump.

The fitting 20 can also comprise, according to a preferred embodiment shown, an electro-weldable adaptor 40 coupled with the smooth cylindrical portion 24.

The adaptor 40 comprises opposite end portions having different internal diameter and each bearing heat transfer means 41 for the electro-welded connection respectively with the smooth cylindrical portion 24 of the cylindrical sleeve 21 and with the outer wall of the conduit 50 passing through the circular opening 13.

Likewise, the heat transfer means 41 of the electro-weldable fitting 40 comprise a metal wire which leads into electrical contacts 42 accessible from the outside for connection to a source of electricity.

Similarly to what has already been illustrated above, the connection of the electrical contacts 42 to a source of electricity requires the passage of electric current through the heat transfer means and, consequently, the transfer of heat to the walls adjacent to these heat transfer means.

The fusion of these walls therefore takes place, creating a fixed coupling between the adaptor 40 and respectively the conduit 50 and the smooth portion 24 of the cylindrical sleeve 21.

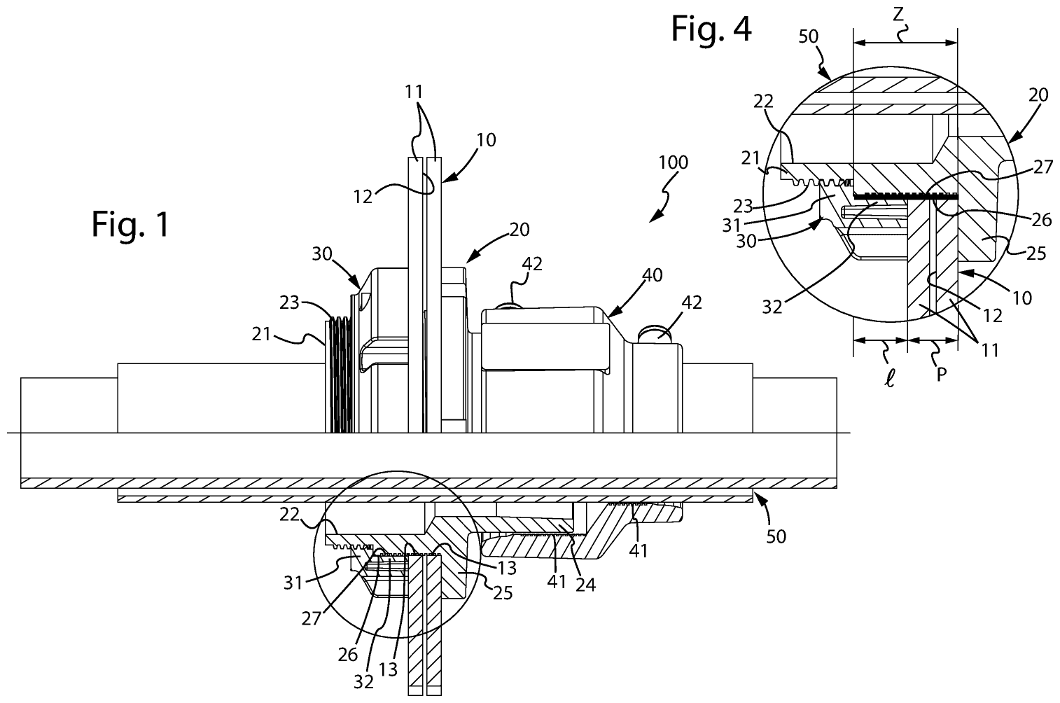

As shown in the figures, the conduit 50 can be both a double wall conduit (FIG. 1) and a single wall conduit 50 (FIG. 2).

Advantageously, the assembly according to the disclosure obviates this problem by ensuring the isolation of the interspace between the walls of the sump.

The assembly comprising a double wall PE sump and an electro-weldable penetration fitting and the relative installation method of the present disclosure have the advantage of guaranteeing the isolation of the interspace between the walls of the sump.

Advantageously, in the assembly according to the disclosure it is possible to monitor the interspace between the walls of the sump to check for any leaks.

The assembly comprising a double wall PE sump and an electro-weldable penetration fitting thus conceived is susceptible to numerous modifications and variations, all of which are within the scope of the disclosure; moreover, all the details can be replaced by technically equivalent elements. In practice, the materials used, as well as the dimensions thereof, can be of any type according to the technical requirements.

1. An assembly comprising: a double wall PE sump and an electro-weldable penetration fitting, wherein the sump is provided with two walls identifying an interspace therebetween and wherein at least an electro-weldable penetration fitting is applied to the sump at at least a circular opening prepared for the passage through the two walls by a conduit, wherein the penetration fitting comprises a cylindrical sleeve internally defining a tubular passage and provided with a threaded portion on the outer surface of a first end, with a cylindrical portion on the opposite end, and centrally with a stop shoulder, as well as with a welding zone, having heat transfer means, provided between the threaded portion and the stop shoulder, and wherein the penetration fitting also comprises a locking ring at least provided with a smooth cylindrical portion configured to be coupled with the welding zone of the cylindrical sleeve provided with the heat transfer means.

2. The assembly according to claim 1, wherein said locking ring also comprises a threaded portion configured to be coupled with the threaded portion of the first end of the cylindrical sleeve.

3. The assembly according to claim 1, wherein the welding zone has a length (z) longer than the total thickness (p) of the sump, wherein the total thickness (p) of the sump is obtained by the sum of the two walls thickness and of the interspace thickness.

4. The assembly according to claim 3, wherein the welding zone has length (z) equal to or less than the sum of the total thickness (p) of the sump and the length (l) of the smooth surface of the locking ring.

5. The assembly according to claim 4, wherein the length (z) of the welding zone is greater than the total thickness (p) of the sump of at least 5 mm.

6. The assembly according to claim 1, wherein the welding zone has a length (z) ranging between 11 mm and 45 mm.

7. The assembly according to claim 1, wherein said penetration fitting comprises an electro-weldable adaptor coupled with the cylindrical portion opposite with respect to the threaded portion.

8. The assembly according to claim 7, wherein the adaptor comprises opposite end portions having a different inner diameter, each one of the end portions having heat transfer means adapted to realize the electro-welded coupling respectively with the cylindrical portion of the cylindrical sleeve and with the outer wall of the conduit passing through the circular opening.

9. An installation method of an assembly comprising a double wall PE sump and an electro-weldable penetration fitting, according to claim 1, the method including the following steps:
positioning the sleeve within the opening of the two walls of the sump with the stop shoulder abutting against a side of the sump wall,
screwing the locking ring on the cylindrical sleeve on the side opposite the wall of the sump with respect to the stop shoulder,
tightening the sump wall between the locking ring and the stop shoulder, and
electro-welding the cylindrical sleeve with the two walls of the sump at the welding zone, wherein the welding is carried out on facing cylindrical surfaces of the cylindrical sleeve and of the opening of the sump walls.

10. The installation method according to claim 9, wherein welding at the welding zone also intervenes between the cylindrical sleeve and the smooth portion of the locking ring.
